(19) United States
(12) Patent Application Publication
(10) Pub. No.: US 2005/0236821 A1
(43) Pub. Date: Oct. 27, 2005

(54) Cold gas generator

(75) Inventors: Achim Hofmann, Polling (DE); Lorenz Seidl, Rechtmehring (DE); Michael Gabler, Muhldorf (DE)

Correspondence Address: TAROLLI, SUNDHEIM, COVELL, & TUMMINO L.L.P.;1111 LEADER BLDG., 526 SUPERIOR AVENUE, CLEVELAND, OH, 44114-1400, US

(73) Assignee: TRW Airbag Systems GmbH

(21) Appl. No.: 11/051,888

(22) Filed: Feb. 4, 2005

(30) Foreign Application Priority Data
Feb. 6, 2004 (DE) 20 2004 001 803.9

(51) Int. Cl. B60R 21/26

(52) U.S. Cl. 280/737

(57) ABSTRACT

A cold gas generator, comprising a pressure chamber that is filled with pressurized gas, a diaphragm that closes the pressure chamber and that is attached at an attachment edge to a bearing wall, a propellant charge arranged outside the pressure chamber for destroying the diaphragm, and a support wall. The support wall is situated radially inwards from the attachment edge in such immediate vicinity to the interior side of the diaphragm that when an exterior-side pressure is exerted upon it, the diaphragm is deformed towards the interior and makes contact with the support wall before being destroyed.

### TECHNICAL FIELD

The present invention relates to a cold gas generator.

### BACKGROUND OF THE INVENTION

Cold gas generators are used especially in vehicle-occupant restraint systems. The pressure chamber contains gas that is stored under extremely high pressure and that escapes when a propellant charge, arranged preferably outside the pressure chamber, is ignited.

The present invention specifically relates to cold, gas generators that operate without projectiles, i.e., the diaphragm that closes the pressure chamber is not opened by means such as a projectile, but rather by the combustion products of the externally disposed propellant charge which flow against the diaphragm and preferably apply such a high pressure upon it that it bursts. The diaphragm is usually a thin metal disk, which is welded on a diaphragm holder on a closed circumference in the area of its edge (either at the outermost edge or near thereto). The diaphragm is preferably welded to an end face of the diaphragm holder, and this end face is oriented towards the interior of the pressure chamber. Under the pressure of the gas, the diaphragm usually bulges outwards. However, if, when the cold gas generator is opened, a high pressure is exerted upon the diaphragm from the outside due to the propellant charge, then the diaphragm bulges in the opposite direction, i.e., towards the interior of the pressure chamber. In this context, the welded seam is additionally stressed, specifically with tension.

It is the objective of the present invention to reduce the stress on the welded seam.

### BRIEF SUMMARY OF THE INVENTION

The invention provides a cold gas generator, comprising a pressure chamber that is filled with pressurized gas, a diaphragm that closes the pressure chamber and that is attached at an attachment edge to a bearing wall, a propellant charge arranged outside the pressure chamber for destroying the diaphragm, and a support wall. The support wall is situated radially inwards from the attachment edge in such immediate vicinity to the interior side of the diaphragm that when an exterior-side pressure is exerted upon it, the diaphragm is deformed towards the interior and makes contact with the support wall before being destroyed.

The terms “exterior side” and “interior side” mean the two sides of the diaphragm, oriented to the outside and to the inside, respectively, as related to the pressure chamber. Thus if the diaphragm, due to the pressure caused by a propellant charge, is deformed towards the interior of the pressure chamber, the support wall helps to absorb a part of this pressure exerted upon the welded seam. The diaphragm can therefore be deformed by a predetermined amount in the opposite direction only radially inwards from the circumferential attachment edge. Therefore, the welded seam is prevented from rupturing, which could lead to flying fragments of the diaphragm. In addition, it is indirectly achieved that the diaphragm breaks open not from the outside but rather from the center. In order to be able to determine that the diaphragm actually reaches the support wall just before being destroyed, it is only necessary to apply to the diaphragm from outside an increasing, if appropriate, a slowly increasing, pressure. As a result of this comparatively slow pressure increase (compared with the abrupt pressure increase when a propellant charge is ignited), the position of the diaphragm with respect to the support wall just before the destruction of the diaphragm can be determined.

A further advantage of the present invention lies in the fact that the opening behavior and the gas pressure can be predetermined within narrow limits.

The bearing wall is preferably a separate diaphragm holder, which is attached, more particularly, welded, to the edge of the pressurized-gas container.

According to one embodiment, the support wall is a separate part with respect to the diaphragm holder.

While it is possible to form the support wall by a separate, inserted piece, which extends into the interior of the pressure chamber, another embodiment provides that the pressurized-gas container itself has an annular indentation, which forms the support wall. The latter embodiment makes it possible to economize on parts.

The indentation should be provided specifically in the vicinity of an opening edge of the pressurized-gas container that extends to the outside, whereas the diaphragm holder is attached to the opening edge.

Specifically, the diaphragm is welded on its exterior side to the bearing wall.

In order that the contact with the support wall not result in rupturing the diaphragm in the area of the resultant contact surface, the support wall should be preferably curved.

In this regard, it has surprisingly been found that there is a certain relationship between the thickness of the diaphragm and the radius of the support wall, measured in the cross-section of the support wall. The radius of the support wall in the contact area should be at least eight times, preferably at least ten times, greater than the thickness of the diaphragm.

In the initial state of the gas generator, when there is no increased outer pressure exerted to the diaphragm, the diaphragm is spaced from the support wall by a gap. Therefore, there does not exist a continuously increasing contact surface between the diaphragm and the support wall immediately when increasing the outer pressure, rather, the gap has to be overcome first before the diaphragm contacts the support wall.

### BRIEF DESCRIPTION OF THE DRAWINGS

FIG. 1 depicts a longitudinal sectional view of a first embodiment of the cold gas generator according to the present invention,

FIG. 2 depicts an enlarged sectional view of the cold gas generator in FIG. 1 in the area of the diaphragm holder, in the non-activated state of the propellant charge,

FIG. 3 depicts a view corresponding to FIG. 2, just before the destruction of the diaphragm,

FIG. 4 depicts a longitudinal sectional view of a cold gas generator according to a second embodiment, and

FIG. 5 depicts a longitudinal sectional view of a cold gas generator according to a third embodiment.

### DETAILED DESCRIPTION OF PREFERRED EMBODIMENTS

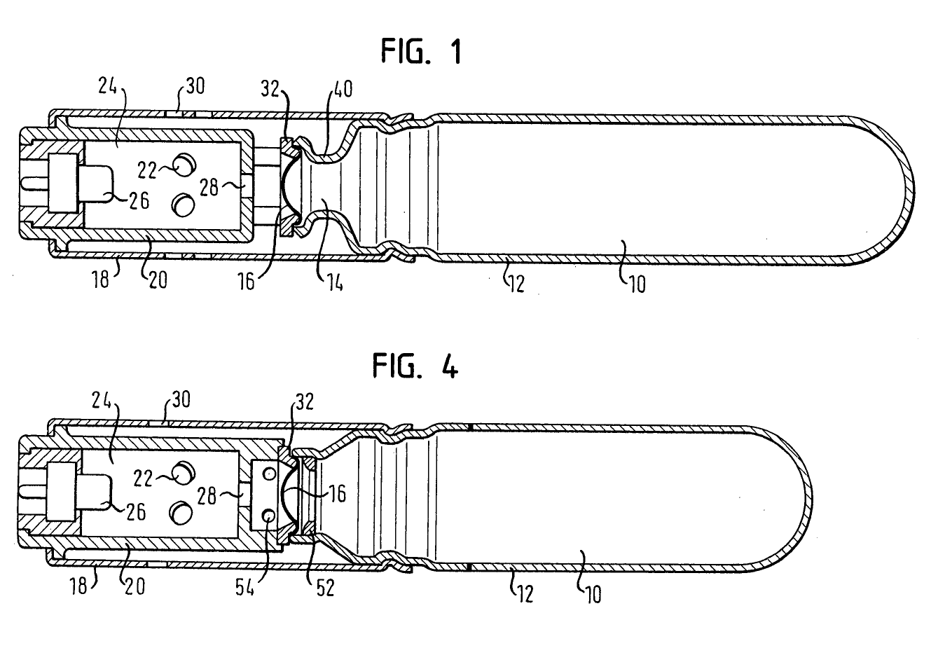

In FIG. 1, a cold gas generator is depicted for inflating a gas bag (not shown) for a vehicle-occupant restraint system. The cold gas generator has a pressure chamber 10 that is filled with compressed gas, the pressure chamber being bordered by a bottle-shaped pressurized-gas container 12. Pressurized-gas container 12 has an end-face discharge opening 14, which is closed by a diaphragm 16. A cylindrical exterior wall 18 is attached by a crimp on pressurized-gas container 12, and it houses a cartridge 20, having a combustion chamber 24 that is filled with a pyrotechnic propellant charge 22, and an igniter 26 for igniting propellant charge 22.

On an end face that is facing diaphragm 16, cartridge 20 has a discharge opening 28 for the pressurized gas that is generated, which flows towards diaphragm 16 when the gas generator is activated. Between cartridge 20 and cylindrical wall 18 there is an annular discharge space for the gas mixture that is generated, made up of the gas flowing out of pressure chamber 10 and the heated gas from combustion chamber 24, which can exit the gas generator via discharge openings 30.

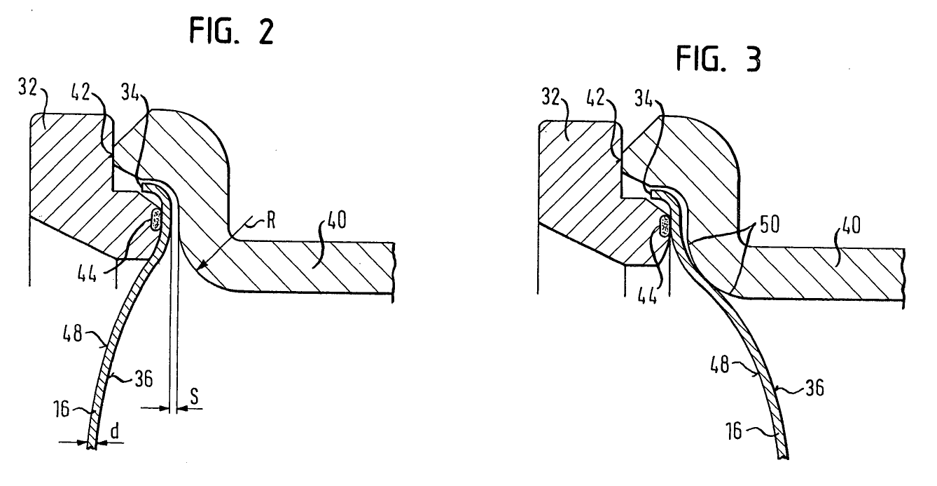

Diaphragm 16 is welded to an annular diaphragm holder 32 (see FIG. 2), specifically in the vicinity of its exterior circumference 34, but spaced away from the latter along an attachment edge 44. Diaphragm 16 is welded at exterior side 48 to diaphragm holder 32, preferably using capacitor discharge welding. Diaphragm holder 32 constitutes the bearing wall for diaphragm 16. The diaphragm 16 may contact the part comprising the support wall 15, more precisely, contact this part at and radially outwards of the attachment edge 44 (explained hereinbelow). However, the diaphragm 16 does not contact the support wall in its movable portion arranged radially inwards of the attachment edge 44. The radially inwards, moving or displaceable portion contacts the support wall 15 only upon exerting a certain outward pressure.

Pressurized-gas container 12 is reshaped radially inwards in the area of discharge opening 14, specifically about diaphragm 16 in the area of its attachment edge 44 (welding location). For this purpose, pressurized-gas container 12 has an annular indentation 40.

Diaphragm holder 32 is welded to an end face 42 of pressurized-gas container 12 in the area of the container's opening edge.

As can be seen in FIG. 2, the pressure in the interior of pressurized-gas container 12 leads to a bulging of diaphragm 16 to the outside, so that the latter makes contact with diaphragm holder 32 not only on its annular attachment edge 44 (see FIGS. 2 and 3), but also radially inwards from the attachment edge.

In the non-activated state of the gas generator, diaphragm 16 in the radially inwards direction from attachment edge 44 is situated at a distance from the interior side of indentation 40. The result is a slot S of roughly 0.2 mm width in the area of attachment edge 44, which increases in the radially inward direction. Radially inwards from attachment edge 44, the interior side of indentation 40 has a radius R that is uniform in cross-section, and that is at least eight, preferably at least ten, times as large as thickness d of diaphragm 16.

If igniter 26 is activated, then propellant charge 22 combusts, and the hot gas that is generated flows through opening 28 towards exterior side 48 of diaphragm 16, so that the latter is deformed towards the interior of pressure chamber 10 (see FIG. 3), because the pressure is greater on exterior side 48 than on interior side 36. In this context, diaphragm 16 makes contact with the interior side of indentation 40 before the diaphragm ruptures, the indentation in this area forming a support wall 50 for diaphragm 16. In this area, which defines support wall 50, a portion of the force exerted upon diaphragm 16 is absorbed, and this force is not transmitted to the welded seam in the area of attachment edge 44, so that the latter is relieved of stress. The support wall 15 is, therefore, a wall portion which is distanced from the movable or displaceable portion of the diaphragm with respect to the initial state of the generator in which only the normal atmospheric pressure exists.

Support wall 50 does not have to be formed by an indentation 40, i.e., an integral section of pressurized-gas container 12. It is also possible, as is shown in FIG. 4, to attach a diaphragm ring 52 on the interior side of pressurized-gas container 12, so that this diaphragm ring 52 forms the support wall for diaphragm 16, which it contacts after the activation of igniter 26. Of course, here too, the interior side of the support wall is provided with an appropriate curvature, as in FIG. 2.

In the alternative embodiment depicted in FIG. 4, furthermore, cartridge 20 abuts against diaphragm holder 32 and is positioned in an end-face groove. Radial discharge openings 54 in the cartridge permit a portion of the hot gas that is generated and of the pressurized gas to flow into the discharge space between cylindrical wall 18 and cartridge 20.

The support wall in the form of diaphragm ring 52 does not necessarily have to be situated at a distance from diaphragm 16 in the area of attachment edge 44. It would also be conceivable to weld three parts to each other in the area of attachment edge 44, for example, also using capacitor discharge welding, i.e., diaphragm holder 32, diaphragm 16, and diaphragm ring 52, which extends radially inwards from attachment edge 44, i.e., from the welded seam, away from combustion chamber 24 and diaphragm 16, as is shown in FIGS. 2 and 3, so that diaphragm 16 contacts the support wall only when a high pressure is applied on exterior side 48.

It is clear from the drawings that the diaphragm 16 is supported on both axial faces in the region of its movable or displaceable central portion. In the initial state, the diaphragm 16 contacts a rounded contact portion of the diaphragm holder radially inwards of the attachment edge 44. Upon exerting a pressure, diaphragm 16 contacts support wall 50.

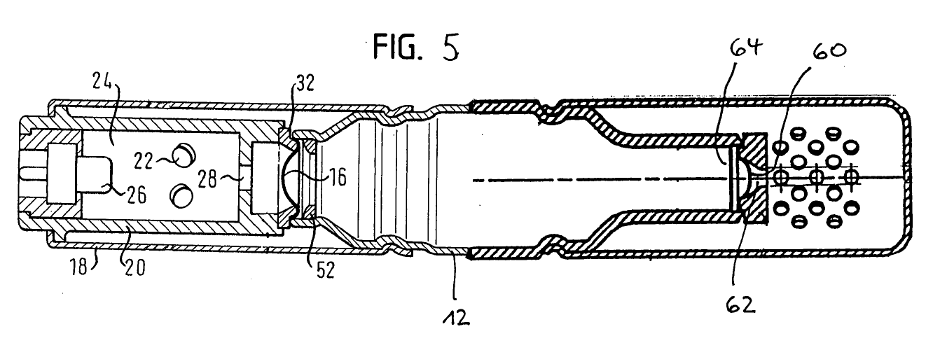

The embodiment according to FIG. 5 shows a gas generator having a gas outlet at its end opposite to the end comprising igniter 26. A pressurized-gas container 12 has an outlet opening 62 closed by a membrane seal 60. A screen 64 is arranged immediately upstream of membrane seal 60. The destruction of membrane seal 60 is achieved by a shock wave generated upon and by destruction of diaphragm 16. The shock wave runs through the pressurized-gas container 12. The fragments of opened diaphragm 16 lie on support wall 50.

1. A cold gas generator, comprising a pressure chamber (10) that is filled with pressurized gas,
a diaphragm (16) that closes said pressure chamber and that is attached at an attachment edge (44) to a bearing wall,
a propellant charge (22) arranged outside said pressure chamber (10) for destroying said diaphragm (16), and
a support wall (50), which is situated radially inwards from said attachment edge (44) in such immediate vicinity to an interior side (36) of said diaphragm (16) that when an exterior-side pressure is exerted upon it, said diaphragm (16) is deformed towards an interior of said pressure chamber (10) and makes contact with said support wall (50) before being destroyed.

2. The cold gas generator as recited in claim 1, wherein said bearing wall is a separate diaphragm holder (32).

3. The cold gas generator as recited in claim 2, wherein said diaphragm holder (32) is attached to an edge of a pressurized-gas container (12) that contains said pressure chamber (10).

4. The cold gas generator as recited in claim 2, wherein said diaphragm holder (32) is welded to a pressurized-gas container (12) that contains said pressure chamber (10).

5. The cold gas generator as recited in claim 2, wherein said support wall (50) is a separate part with respect to said a diaphragm holder (32).

6. The cold gas generator as recited in claim 2, wherein a pressurized-gas container (12) containing said pressure chamber (10) has an annular indentation (40), which forms said support wall (50).

7. The cold gas generator as recited in claim 2, wherein a pressurized-gas container (12) containing said pressure chamber (10) has an annular indentation (40), which forms said support wall (50), said indentation (40) is provided in said vicinity of an outwardly extending opening edge of said pressurized gas container (12), and said diaphragm holder (32) is attached to said opening edge.

8. The cold gas generator as recited in claim 1, wherein said diaphragm (16) is welded on its exterior side (48) to said bearing wall.

9. The cold gas generator as recited in claim 1, wherein said support wall (50) is curved in said contact area of said diaphragm (16).

10. The cold gas generator as recited in claim 1, wherein said support wall (50) in said contact area, viewed in cross-section, has a radius (R) that is at least eight times greater than said diaphragm thickness (d).

11. The cold gas generator as recited in claim 1, wherein said support wall is a separate part that is coupled to said pressurized-gas container (12).

12. The cold gas generator as recited in claim 1, wherein said support wall (50) is distanced from said diaphragm (16) by a gap in the initial state of the gas generator.

13. The cold gas generator as recited in claim 1, wherein said pressurized-gas container (12) has outlet openings at an end opposite to its end comprising diaphragm (16), the end opposite to the end comprising diaphragm (16) being closed by a membrane seal (60).
